(19) United States
(12) Patent Application Publication
(10) Pub. No.: US 2020/0167117 A1
(43) Pub. Date: May 28, 2020

(54) ELECTRONIC IMAGE DISPLAY SYSTEM FOR A VEHICLE COCKPIT HAVING A DISPLAY AREA OF DEVELOPABLE SHAPE

(71) Applicant: THALES, Courbevoie (FR)

(72) Inventors: Loïc BECOUARN, Mérignac (FR); Florent MENNECHET, Mérignac (FR); Valery BOTA, Mérignac (FR)

(21) Appl. No.: 16/691,220

(22) Filed: Nov. 21, 2019

(30) Foreign Application Priority Data
Nov. 23, 2018 (FR) 18 71754

(51) Int. Cl. G06F 3/14; B64D 43/00

(52) U.S. Cl. CPC G06F 3/1423; B64D 43/00

(57) ABSTRACT

The display system has a non-planar three-dimensional display surface defined by an electronic display screen or a plurality of contiguous electronic display screens, the display surface having at least one curved display area having the form of a developable surface.

### CROSS-REFERENCE TO RELATED APPLICATIONS

This application claims priority to French Patent Application No. 18 71754, filed on Nov. 23, 2018. The disclosure of the priority application is incorporated in its entirety herein by reference.

### FIELD OF THE INVENTION

The present invention relates to the field of display s for a vehicle cockpit, for example an aircraft cockpit.

### BACKGROUND AND SUMMARY

A current trend in aircraft cockpit display systems is to provide tactile display screens and to increase the size of these display screens.

However, the simple replacement of existing display screens with larger tactile display screens leads to problems of the layout of the display screens and the ergonomics of the cockpit, especially for cockpits for two pilots that are configured to be used by two pilots sitting side by side and partly sharing the same display system. This problem is also present in the case of a single pilot cockpit where flat tactile screens do not allow optimal use of the available space.

In addition, the aircraft cockpit display systems must comply with standards in terms of available space for each pilot, accessibility of the different functions for each pilot, difficulty in accessing the different functions for each pilot and visibility of the outside, wherein the display system must not hinder the vision of the pilot(s) of the outside of the aircraft.

Furthermore, the display system must be reliable and achievable at an acceptable cost with a view to industrialization.

One of the objects of the invention is to propose a vehicle cockpit display system that is ergonomic and that can be produced at a reasonable cost.

For this purpose, the invention proposes an electronic image display system for a vehicle cockpit, wherein the display system has a non-planar three-dimensional display surface defined by an electronic display screen or several contiguous electronic display screens, the display surface having at least one curved display area in the form of a developable surface.

According to particular embodiments, the display system comprises one or more of the following optional features, taken individually or in any technically feasible combination:
each curved display area of the display surface is a curved display area in the form of a developable surface;
at least one curved display area in the form of a developable surface is defined by a single display screen and/or at least one curved display area in the form of a developable surface is defined by a plurality of contiguous display screens;
the display surface consists of several curved display areas each having the shape of a developable surface;
at least one, or each, curved display zone in the form of a developable surface is in the form of a conical surface portion, in particular in the form of a portion of a conical surface of revolution;
each display screen defining, in whole or in part, a curved display area in the form of a developable surface is in the form of a conical surface portion, in particular a portion of a conical surface of revolution;
at least one display screen is in the form of a portion of a conical surface of revolution delimited between two parallel planes perpendicular to the axis of revolution of the conical surface of revolution, and two distinct axial planes including the axis of revolution by making a non-zero angle between them;
the display surface consists of one or more display screens each having the shape of a portion of a frustoconical surface of revolution delimited between two parallel planes perpendicular to the axis of revolution of the frustoconical surface of revolution, and two distinct axial planes including the axis of revolution with making a non-zero angle between them;
at least one curved display zone is concave and/or at least one curved display zone is convex; and
the display surface comprises three adjacent curved display areas including a convex curved display area located between two concave curved display areas;

The invention also relates to a cockpit of a vehicle, for example of an aircraft, comprising an electronic display system as defined above and a vehicle, for example an aircraft, comprising such a cockpit.

### BRIEF DESCRIPTION OF THE FIGURES

The invention and its advantages will be better understood upon reading the description which follows, given solely by way of non-limiting example, and with reference to the appended drawings, wherein:

FIG. 1 shows a schematic perspective view of an individual cockpit including an electronic image display system;

FIG. 2 shows a schematic perspective view of a cockpit for two pilots, including an electronic image display system;

FIG. 3 shows a schematic perspective view of a cockpit for two pilots, comprising an electronic image display system with more screens than in FIG. 2;

FIG. 4 shows a schematic plan view of a display area of an electronic image display system for an individual cockpit; and

FIG. 5 shows a schematic sectional view of the display area, according to V-V in FIG. 4.

### DETAILED DESCRIPTION

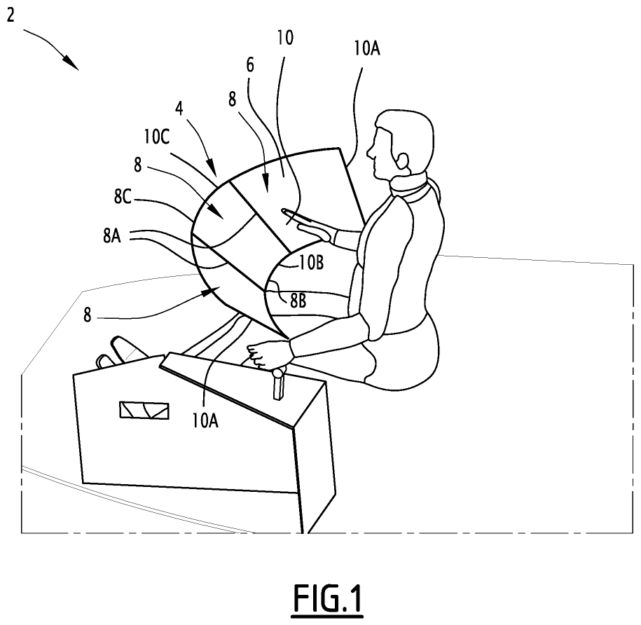

The cockpit 2 of FIG. 1 shows a vehicle cockpit, for example the cockpit of an aircraft. The aircraft may be, for example an airplane, a drone (i.e. an aircraft without a human pilot on board) or a helicopter.

In a variant, the cockpit may be a cockpit of a railway vehicle, a maritime vehicle, for example a surface vessel or a submarine, or a road vehicle, for example a car or a truck.

The cockpit 2 is located inside or outside the vehicle and is designed for remote vehicle control, such as, for example, in the case of a drone.

The cockpit 2 includes an electronic image display system 4 designed to display images. The display system 4 may be used, for example, to display vehicle control parameters.

In the case of an aircraft, the display system 4 is generally designed to display data such as piloting data, navigation data or data representing the state of the systems (motors, hydraulics, electrics, . . . ).

The display system 4 has a three-dimensional image display surface that is defined by a single electronic image display screen 8 or multiple contiguous electronic image display screens 8.

Each display screen 8 is designed to generate images. Each display screen 8 comprises, for example, an assembly of pixels distributed on the display screen 8 and designed to emit light in order to jointly generate an image perceptible by an observer.

In an exemplary embodiment, each display screen 8 may be, for example, electro-luminescent, for example in the form of a light-emitting diode (LED) screen, in particular an organic light-emitting diode (OLED) screen.

In an exemplary embodiment, allowing, in particular, the absence of a visible edge, each display screen 8 may be a micro-LED display screen. In a known manner, the light-emitting diodes of a micro-LED screen generate light from an inorganic material.

In another exemplary embodiment, each screen could implement a more conventional liquid crystal display (LCD) technology.

In an exemplary embodiment, each display screen 8 has no visible edge so that the entire display surface 6 appears continuous to the user. Such display screens 8 without a visible edge are, for example, micro-LED screens.

Preferably, the display surface 6 is at least partly tactile, and, in particular, fully tactile. At least one, or each, display screen 8 is tactile to achieve this.

The tactile nature of the display surface 6 allows each pilot to interact with the display system 4, either to configure the display of the data on the display surface 6, or to interact with and/or control on-board vehicle systems, such as measuring systems or propulsion systems, guidance systems . . . .

The display surface 6 comprises at least one curved display area 10 in the form of a developable surface, in particular a portion of a conical surface, still more particularly a portion of a conical surface of revolution.

Each curved display area 10 is three-dimensional. Each curved display area 10 is non-planar. Each curved display area 10 is preferably without any interruption or edge.

A developable surface is by definition a ruled surface, i.e. it is formed of an infinity of straight lines called “generatrix lines”, wherein any generatrix line is stationary, i.e. so that the plane tangent to the developable surface is the same at every point of the generatrix line.

A conical surface (or cone) is by definition a ruled surface generated by generatrix lines passing through a fixed point called a vertex and a variable point describing a curve called the guide curve.

A conical surface here designates a non-cylindrical surface. A cylindrical surface is not considered here as a conical surface.

In the rest of the description, for the sake of brevity, unless otherwise indicated, the term “curved display area” designates a curved display area in the form of a developable surface, and, in particular, a portion of a conical surface.

Moreover, the expression “generatrix line” designates a generatrix line of the developable surface, and, in particular in the case of a conical surface, a generatrix line passing through the vertex of the conical surface and by the guide curve of the conical surface.

A conical surface of revolution (or “straight circular conical surface”) is a conical surface having a vertex located on an axis of revolution and a circular guide curve located in a plane perpendicular to the axis of revolution and whose center is located on the axis of revolution. In an exemplary embodiment, at least one or each curved display area 10 has the shape of a portion of a conical surface of revolution delimited between two parallel planes perpendicular to the axis of revolution of the conical surface of revolution, and two straight lines of the conical surface of revolution.

Such a curved display zone 10 corresponds to a fraction of the lateral surface of a frustoconical surface of revolution.

Such a curved display area 10 is delimited by two opposite straight edges 10A and two opposite curvilinear edges 10B, 10C.

The two rectilinear edges 10A correspond to two straight lines of the frustoconical surface of revolution,

The two curvilinear edges 10B, 10C are arcs of circles of different radii and lengths. The two curvilinear edges 10B, 10C are centered on the axis of revolution of the frustoconical surface of revolution.

When the curved display area 10 is concave, as is the case in FIG. 1, preferably, the short curvilinear edge 10B and the long curvilinear edge 10C respectively define the lower edge and the upper edge of the curved display area 10.

When the curved display area 10 is convex, the short curvilinear edge and the long curvilinear edge preferably respectively define the top edge and the bottom edge of the curved display area 10.

Each curved display area 10 of the display surface is preferably upwardly oriented. Thus, the pilot seated in his cockpit is able to view the display area 10 by looking obliquely downwards.

The axis of revolution of the conical surface of revolution, of which the curved display area 10 forms a portion, is preferably substantially vertical.

Each display screen 8 defining a curved display area 10 is itself curved and has the form of a developable surface, and, in particular, a conical surface portion, and even more particularly the shape of a portion of a conical surface of revolution.

In a particular embodiment, at least one or each display screen 8 may have the shape of a portion of a conical surface of revolution delimited between two parallel planes perpendicular to the axis of revolution of the frustoconical surface of revolution, and two straight lines of the conical surface of revolution.

Each display screen 8 of this type corresponds to a fraction of the lateral surface of a truncated cone of revolution.

Each display screen 8 of this type is delimited by two opposite straight edges 8A corresponding to two straight lines of the conical surface of revolution, and two opposing curvilinear edges 8B, 8C.

The two opposing curvilinear edges 8B, 8C are arcs of circles of different radii and lengths. The two curvilinear edges 8B, 8C are centered on the axis of revolution of the frustoconical surface of revolution.

In the exemplary embodiment illustrated in FIG. 1, the curved display area 10 of the display surface 6 is in the form of three display screens 8 which are each a portion of a conical surface of revolution, arranged side by side and joined by their respective straight edges 8A.

The short curvilinear edges 8B of the display screens 8 extend to form the short curvilinear edge 10B of the curved display area 10, while the long curvilinear edges 8C of the display screens 8 extend to form the long curvilinear edge 10C of the curved display area 10.

The curved display area 10 is angularly wider around the axis of revolution of the conical surface of revolution of which the curved display area 10 is a portion, wherein each of the display screens 8 forms the display area curve 10.

Advantageously, at least two display screens 8 forming the same curved display area 10, while, in particular and as illustrated in FIG. 1, all the display screens 8 forming the same curved display area 10 are identical.

This makes it possible to construct the curved display area 10 which is developable, and, in particular a portion of the conical surface, in a modular manner from identical display screens 8, by adapting the number of display screens 8 to the desired extent of the curved display area 10 which is a developable surface, and, in particular, a portion of the conical surface.

The display screens 8 here are three in number, but of course, in possible variants, a curved display area may be formed by one display screen, two contiguous display screens or more than three contiguous display screens. The exact number of screens depends, among other things, on the availability of information in the event of the failure of one of the screens or the available space in the cockpit.

In the embodiment of FIG. 1, the display surface 6 comprises a single curved display area 10 which is concave.

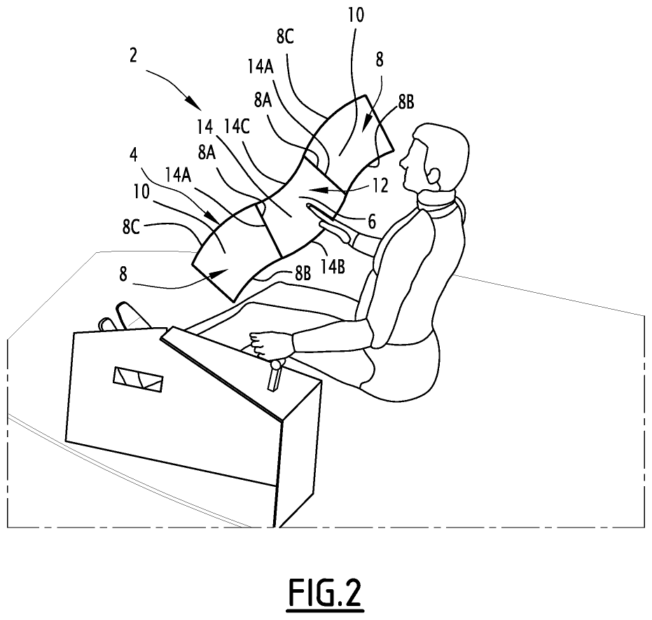

The cockpit of FIG. 2 differs from that of FIG. 1 in that the display surface 8 has a plurality of distinct curved display areas 10, 12, here including a convex curved display area 12 situated between two concave curved display areas 10.

The cockpit of FIG. 2 is, for example, provided for two pilots sitting side by side.

Each concave curved display area 10 defines a display area dedicated to one pilot and in front of this pilot, while the curved convex display area 12 defines a display area between the pilots and shared by the pilots.

In the embodiment of FIG. 2, each curved display area 10, 12 is in the form of a developable surface, in particular a portion of a conical surface, more particularly here a portion of a conical surface of revolution, delimited between two planes perpendicular to the axis of revolution of the conical surface of revolution, and between two generatrix lines of the frustoconical surface of revolution.

Each curved display area 10, 12 is here formed by a single display screen 8, 14 having a shape coinciding with that of the corresponding curved display area 10, 12.

Advantageously, when the display surface 6 comprises a concave curved display area 10 and an adjacent convex curved display area 12, these are respectively formed by a concave display screen 8 and a convex display screen 14 respectively made contiguous by the straight edges 8A, 14A.

The concave display screen 8 and the display screen 14 each have the form of a developable surface, in particular a conical surface portion, more particularly here a portion of a conical surface of revolution.

Preferably, the concave display screen 8 and the display screen 14 each have the shape of a portion of a frustoconical surface of revolution delimited between two parallel planes perpendicular to the axis of revolution of the conical surface of revolution, and two distinct guide lines of the conical surface of revolution.

In a preferred embodiment, the concave display screen 8 and the convex display screen 14 have straight edges 8A, 14A of the same length. This makes it possible to arrange the display screens 8, 14 at their rectilinear edges 8A, 14A so that they extend one another.

Optionally, the concave display screen 8 and the convex display screen 14 may have short curvilinear edges of the same radius of curvature and long curvilinear edges of the same radius of curvature.

In this case, the screens 8 and 14 are, for example, derived from the same curved planar shape on a concave surface for the screen 8 and pivoted 180° and then curved on a convex surface for the screen 14. The development costs are thus minimized by using the same starting shape.

The convex display screen 14 is so arranged that its long curvilinear edge 14B defines a lower edge of the convex curved display area 12, while its short curvilinear edge 14C defines an upper edge of the convex curved display area 12.

In general, one could have concave and convex display screens 8, 14 with long edges of different radii of curvature and/or with short edges of different radii of curvature, for example with matrices of different pixels between the concave and convex screens.

Preferably, the convex display screen 14 is arranged upside down with respect to each concave display screen 8 with which it is contiguous.

Advantageously, the curvilinear edge 14B along the convex display screen extends the short curvilinear edge 8B of each contiguous concave display screen 8 and/or the short curvilinear edge 14C of the convex display screen 14 extends the curvilinear edge 8C along each contiguous concave display screen 8.

The use of such concave and convex display screens 8, 14 arranged upside down makes it possible to form a curved display surface in the form of an undulating band with an alternation of concave and convex display areas 10, 12. Such a band is particularly ergonomic for the arrangement of a cockpit for two pilots. In the embodiment of FIG. 2, each curved display area 10, 12 is in the form of a single display screen. Alternatively, at least one curved display area 10, 12 may be in the form of several contiguous display screens.

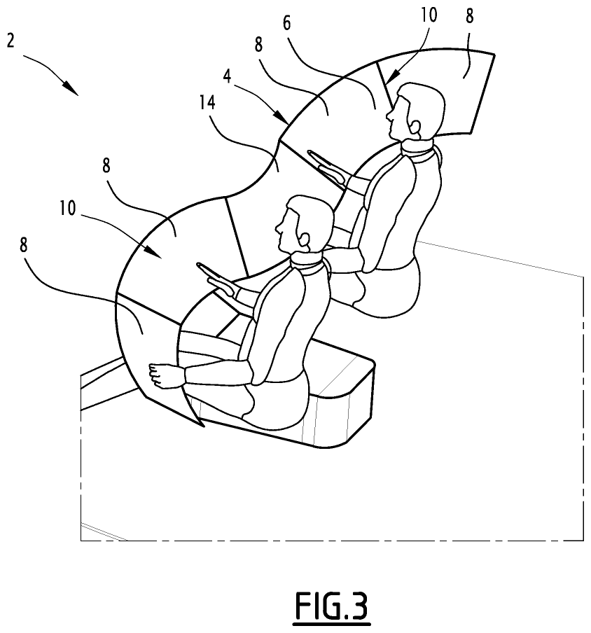

The cockpit of FIG. 3 differs from that of FIG. 2 in that each curved concave display area is formed of two contiguous display screens 8 arranged side by side.

In the illustrated example, the two display screens 8 forming each curved display area 10 are different, one being wider than the other.

In a possible variant, a single curved concave display area may be in the form of a plurality of adjacent display screens 8 arranged side by side, the other curved concave display area being in the form of a single display screen 8.

Furthermore, optionally or alternatively, the display surface may comprise at least one curved convex display area 12 in the form of several contiguous display screens 8.

In general, the display surface 6 comprises at least one curved concave display area 10 in the form of a single display screen 8, at least one concave curve display area 10 in the form of a plurality of contiguous display screens 8, at least one curved convex display area 12 in the form of several contiguous display screens 14 and/or at least one curved convex display area 12 in the form of a single display screen 14.

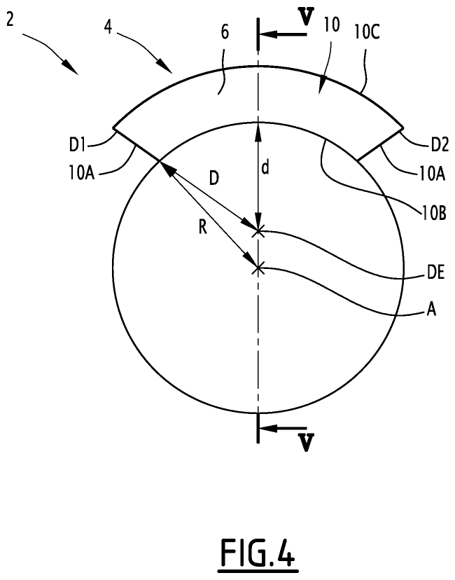

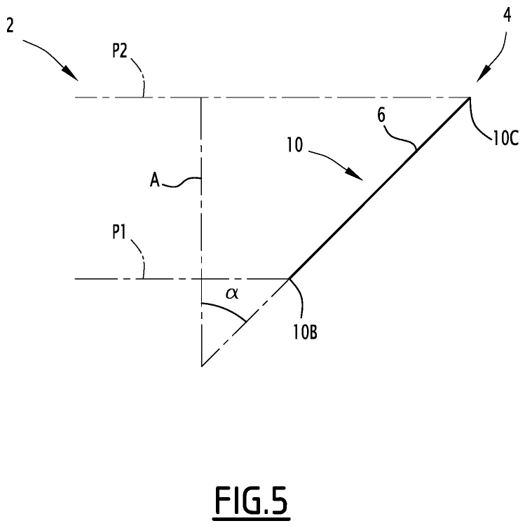

FIG. 4 shows a plan view of a curved concave display area 10 dedicated to a pilot, while FIG. 5 shows the sectional view area according to V-V in FIG. 4.

The curved concave display area 10 is a portion of a frustoconical surface of revolution having an axis of revolution A, situated between two distinct parallel planes P1, P2 (FIG. 5) perpendicular to the axis of revolution A, and two segments of the generatrix lines D1, D2 of the conical surface of revolution (FIG. 4). The segments of the generatrix lines D1, D2 correspond to the side edges 10A of the curved display area 10.

In FIGS. 4 and 5, the viewing point DE represents the position of a theoretical viewing point of a pilot sitting in front of the display area, to be taken into account for the design of the display area.

The axis of revolution A of the conical surface is substantially vertical (FIG. 4). Furthermore, in section in a vertical plane (FIG. 5), the conical curved display area extends obliquely upwards.

Preferably, when seen from above, the viewing point DE is located between the axis of revolution A and the point of the lower edge of the display area in front of the pilot.

Thus, the distance d between the viewing point DE and the point of the lower edge of the display area in front of the pilot is less than the radius of curvature R of the lower edge 10B.

Preferably, the radius of curvature of the inner edge is chosen so that a distance d between the viewing point DE and the point of the lower edge of the display area in front of the pilot is strictly less than a distance D between the viewing point DE and each end of the lower edge 10B of the curved display area 10.

Typical values are a distance d between 400 and 450 mm, for example about 430 mm, and a distance D between 550 and 600 mm, for example about 580 mm. Moreover, preferably, the half-angle at the vertex a (FIG. 5) of the conical surface of revolution associated with each conical curved display area having the form of a portion of a conical surface of revolution, is between 30° and 55°.

The half-angle at the vertex of the conical surface of revolution is the angle defined inside the conical surface of revolution between the axis of revolution A of the conical surface of revolution and a generatrix line of the conical surface of revolution.

The specified angular range makes it possible to obtain a curved display area having satisfactory ergonomics, in terms of visibility of the images for the pilot as well as accessibility, for example when the curved display area is at least partially tactile to allow the pilot to interact with the display system.

The creation of an image display surface in the form of a display screen or several contiguous display screens makes it possible to provide an extended display surface. This makes it possible to increase the amount of information displayed simultaneously, and to improve the sharing of information between pilots.

The provision of a curved display area in the form of a developable surface, in particular a portion of a conical surface, and even more particularly of such a display area for each pilot, makes it possible to obtain satisfactory ergonomics.

The curved display area causes the display surface to conform to the accessibility envelope of each pilot for easier interaction.

This reduces the muscular effort on the part of the pilots to interact with the display surface when it is at least partially tactile, and improves the stability of the fingers of the pilots, which allows more precise and easier use.

The creation of the display surface with several contiguous display screens makes it possible to maximize the display surface and to display formats that straddle several screens. It also facilitates the exchange of information between the pilots, for example by allowing them to move an image generated on the display surface from one pilot to the other in order to share information contained in this image.

Achieving the display surface with multiple contiguous display screens also offers increased security by allowing the display system to continue operating in a degraded mode, including when one of the display screens fails. In particular, at least one, or each, display area can be created using several contiguous display screens.

For the creation of the described display systems, a display screen in the form of a portion of a conical surface, in particular of a portion of a conical surface of revolution, may be, for example, formed by providing a flexible display screen in the form of an angular circular crown sector, and fixing this flexible screen on a rigid support surface which is a portion of a frustoconical surface of revolution.

A flexible display screen may be, for example, an OLED screen, a micro-LED screen, an LCD screen on thin glass or an LCD screen on plastic.

Alternatively, such a display screen may be formed by attaching light generating elements such as LEDs, OLEDs or micro-LEDs to a support surface which is a portion of a frustoconical surface of revolution.

The invention is not limited to the embodiments described, variants being conceivable.

For example, the display systems of the exemplary embodiments of FIGS. 1 to 3 have a plurality of separate display screens that are arranged contiguously to form a larger display area than each display screen.

In one variant, the display surface is formed by a single curved display screen defining a curved display area in the form of a developable surface, in particular a conical surface, or a plurality of curved display areas having the form of developable surfaces, in particular conical.

Furthermore, in the embodiments described, the display surfaces exclusively comprise curved display areas in the form of a developable surface, in particular a conical surface portion.

In variants, it is conceivable for a display surface to have at least one non-curved display area and/or a curved but non-developable or non-conical display area, for example at least one planar display area and/or at least one curved display area in the form of a cylindrical surface portion.

1. Electronic image display system for a vehicle cockpit, the display system having a non-planar three-dimensional display surface defined by electronic display screen or multiple contiguous electronic display screens, the display surface having at least one curved display area in the form of a developable surface.

2. Display system according to claim 1, wherein each curved display area of the display surface is a curved display area in the form of a developable surface.

3. Display system according to claim 1, wherein at least one curved display area in the form of a developable surface is defined by a single display screen and/or or at least one curved display, area in the form of a developable surface is defined by a plurality of contiguous display screens.

4. Display system according to claim 1, wherein the display surface consists of a plurality of curved display areas each having the form of a developable surface.

5. Display system according to claim 1, wherein at least one, or each, curved display area in the form of a developable surface is in the form of a portion of a conical surface.

6. Display system according to claim 1, wherein each display screen defines, in whole or in part, a curved display area having the shape of a developable surface is in the form of a portion of a conical surface.

7. Display system according to claim 1, wherein at least one display screen has the shape of portion of a conical surface of revolution delimited between two parallel planes perpendicular to the axis of revolution of the conical surface of revolution, and two distinct axial planes including the axis of revolution and having a non-zero angle between them.

8. Display system according to claim 1, wherein the display surface comprises one or more display screens each having the shape of a portion of a frustoconical surface of, revolution, delimited between two parallel planes perpendicular to the axis of revolution of the frustoconical surface of revolution, and two distinct axial planes including the axis of revolution and having with making a non-zero angle between them.

9. Display system according to claim 1, wherein at least one curved display area is concave or at least one curved display area is convex.

10. Display system according to claim 1, wherein the display surface comprises three contiguous curved display areas including a convex curved display area located between two curved concave display areas.

11. Vehicle cockpit, for example of an aircraft, comprising an electronic display system according to claim 1.

12. Display system recording to claim 5, wherein the developable surface is in the form of a portion of a conical surface of the revolution.

13. Display system according to claim 6, wherein the developable surface is in the form of a portion of a conical surface of revolution.

14. Vehicle cockpit according to claim 11, wherein the vehicle is an aircraft.
